(19) United States
(12) Patent Application Publication
(10) Pub. No.: US 2002/0027498 A1
(43) Pub. Date: Mar. 7, 2002

(54) Automobile vehicle equipped with a sophisticated "hands-off" access system to determine the localization of a portable badge

(76) Inventor: Etter Stephane, Gif Sur Yvette (FR)

Correspondence Address: Matthew W. Stavish, Esq., Liniak, Berenato, Longacre & White, Ste. 240, 6550 Rock Spring Drive, Bethesda, MD, 20817, US

(21) Appl. No.: 09/895,179

(22) Filed: Jul. 2, 2001

(30) Foreign Application Priority Data
Jul. 3, 2000 (FR) 0008619

(51) Int. Cl. B60Q 1/00

(52) U.S. Cl. 340/425.5; 340/539; 340/572.1

(57) ABSTRACT

The automobile vehicle (V) is equipped with a “hands-off” access system comprising a recognition device placed in the vehicle with several antennas and a portable identification device or badge for remote communication with the recognition device to automatically control locking or unlocking of the said vehicle doors and/or authorization to start the said vehicle. The said antennas have intersecting coverage areas (Z1, Z2, Z3), and the recognition device is designed to activate each antenna in turn in order to detect a response or lack of response of the identification device depending on which antenna is activated and to localize the presence of the identification device in a particular coverage area of the antennas based on detections of response or lack of response of the identification device.

The invention relates to an automobile vehicle equipped with a “hands-off” access system comprising a recognition device placed in the vehicle with several emission antennas and a portable identification device for remote communication with the recognition device to automatically control locking or unlocking of the doors of the said vehicle and/or authorization of the said vehicle to start.

The identification device for this type of access system is in the form of a small badge to be worn or carried by the vehicle user so that he does not need to perform any operations with a key or a remote control to lock or unlock his vehicle, or to start it In a vehicle equipped with this type of hands-off access system, several emission antennas are used for the recognition device to cover the entire passenger compartment of the vehicle and the immediate vicinity of the vehicle from outside the vehicle. These emission antennas of the multi-strand loop type are usually positioned in the vehicle so that they cover separate areas and are activated at the same time to set up communication with the identification device present in the area covered by the antennas.

The purpose of the invention is to improve such a hands-off access system to make it capable of fairly precisely identifying the area in which the identification device is localized within the antenna coverage area.

Consequently, the purpose of the invention is an automobile vehicle equipped with a “hands-off” access system comprising a recognition device placed in the vehicle with several antennas and a portable identification device capable of remote communication with the recognition device to automatically control locking or unlocking of the doors of the said vehicle and/or authorization of the said vehicle to start, characterized in that the said antennas have intersecting coverage areas and in that the said recognition device is designed to activate each antenna in sequence in order to detect response or lack of response of the identification device depending on which antenna is activated and to localize the presence of the identification device in a particular coverage area of the said antennas based on detections of the response or lack of response of the identification device depending on which antennas are activated. If several antennas are used with coverage areas that overlap partially or entirely, the identification device may be localized in an area corresponding particularly to the intersection of two coverage areas of antennas that partially overlap.

An example embodiment of the vehicle with a hands-off access system according to the invention is described below and is illustrated on the attached drawings.

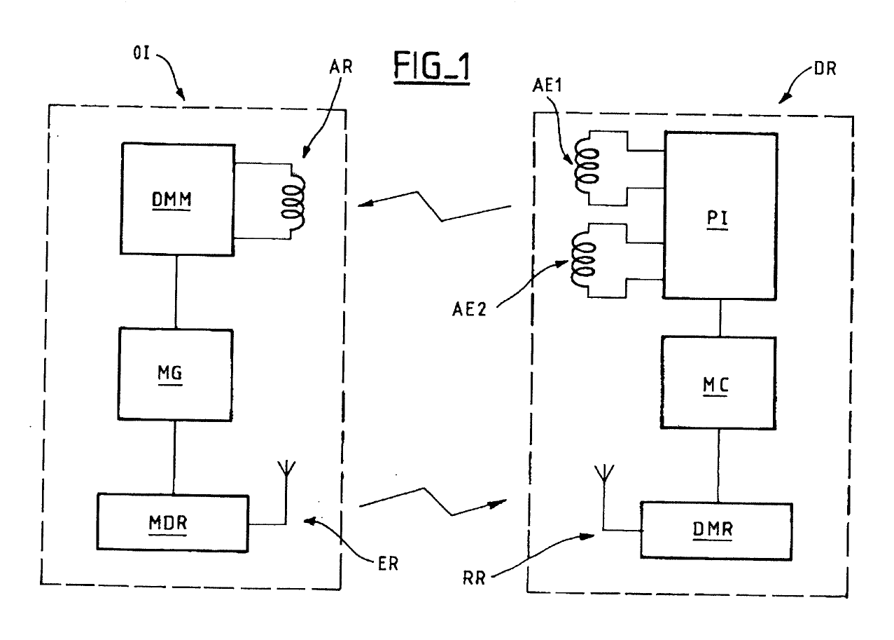

FIG. 1 is a diagrammatic representation of a hands-off access system according to the invention,

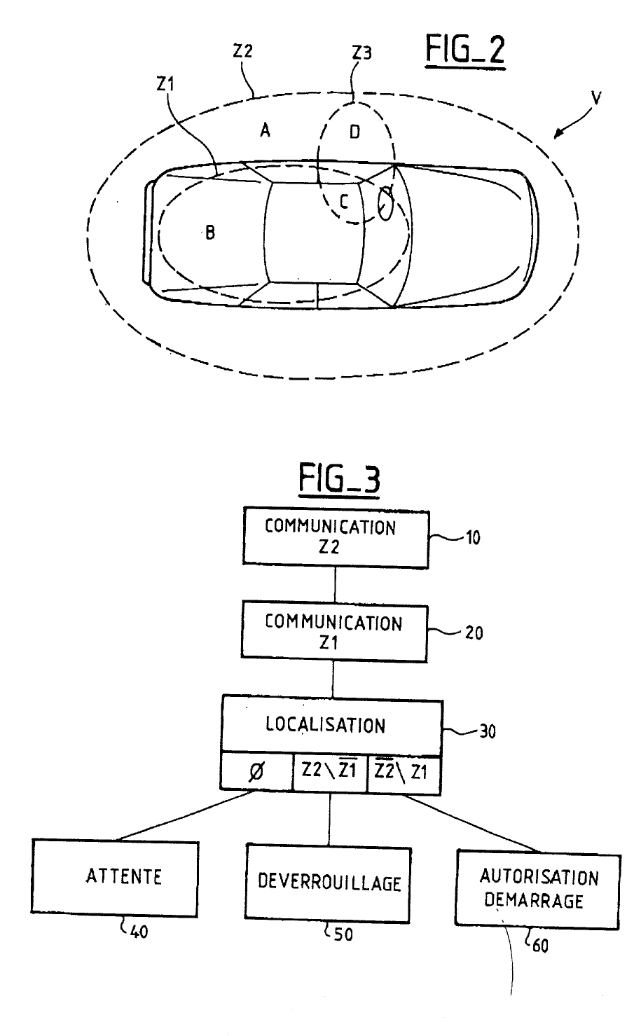

FIG. 2 is a diagrammatic representation of a vehicle equipped with a hands-off access system according to the invention,

FIG. 3 is a flow chart illustrating the processing logic of the recognition device according to the invention,

FIG. 1 very diagrammatically shows an identification device Ol and a recognition device DR forming a “hands-off” access system according to the invention for use on a vehicle.

The recognition device DR of this access system comprises several antennas emitting a magnetic field, in this case two antennas AE1 and AE2 that are activated independently by an antenna driver PI. These antennas are designed and arranged in the vehicle such that they have different coverage areas that intersect as will be seen later. Obviously, each antenna may have its own antenna driver PI without going outside the framework of the invention.

The antennas AE1, AE2 emit signals that will be received by an antenna receiving the magnetic field AR of the identification device OI. The antenna AR is connected to a demodulator DMM, itself connected to a management module MG for the identification device. In response to the reception of signals emitted by the recognition device through antennas AE1, AE2, the management module MG sends response signals through a radio frequency modulator MGR and a radio frequency emission antenna ER. The recognition device DR receives these radio frequency signals through a radio frequency receiver antenna RR and a radio frequency demodulator DMR.

The antenna driver(s) PI and the radio frequency demodulator DMR are connected to a microcontroller MC that is programmed to perform authentication operations of the identification device OI before automatically controlling locking or unlocking of the vehicle doors and/or providing authorization of the vehicle to start.

FIG. 2 shows a vehicle V equipped with a hands-off access system according to the invention. The recognition device DR is installed inside the vehicle with several magnetic field emission antennas. The recognition device with magnetic field emission antennas are not shown in FIG. 2, which only shows the coverage areas of each of these magnetic field emission antennas, in this case three coverage areas Z1, Z2 and Z3 corresponding to three antennas.

As can be seen in FIG. 2, the first coverage area Z1 is oval shaped and surrounds the inside of the passenger compartment of the vehicle V without projecting outside the vehicle. The second oval shaped coverage area Z2 surrounds the inside and outside of the vehicle. The third oval shaped coverage area Z3 surrounds the driver's seat inside the vehicle and close to the driver's door from outside the vehicle. It can be seen that the coverage areas Z1, Z2 and Z3 intersect, in other words they are partially or completely overlapping to define a set of particular areas A, B, C, D in which the identification device OI may be localized.

According to the invention, the recognition device DR is laid out to activate each antenna corresponding to areas Z1 to Z3 in turn, and then to detect a response or lack of response of the identification device depending on which antenna is activated, in order to localize the identification device. Based on detections of replies from the identification device as a function of the activated antennas, the recognition device is capable of using a simple logical combination, for example, to localize one of the areas A, B, C or D in which the identification device is localized, and subsequently to appropriately control locking or unlocking of the doors of the said vehicle and/or authorization of the vehicle to start.

Thus, if two-directional communication is possible between the recognition device DR and the identification device OI in coverage area Z1 but not in coverage area Z2, the identification device must be localized in area B or C inside the vehicle V, and for example the recognition device can control authorization of the vehicle to start. If this two-directional communication is not possible in coverage area Z1, and is possible in coverage area Z2, this means that the identification device is localized in area A outside the vehicle and close to it and, for example, the recognition device can unlock the vehicle doors. If this communication is possible both in coverage area Z1 and coverage area Z3, then the identification device is in area C on the vehicle driver's seat. If this two-directional communication is possible in coverage area Z3 but not in coverage area Z1, then the identification device is in area D outside the driver's door.

With this type of device, the fact that the coverage areas intersect makes it possible for the number of areas in which the identification device OI could be localized to be greater than the number of antennas used by the recognition device. Thus, coverage areas Z1, Z2 and Z3 can define four localization areas A, B, C and D.

FIG. 3 is a flow chart illustrating the operating logic of the recognition device DR, particularly for the microcontroller MC, in the case in which it comprises only two magnetic field emission antennas such as AE1 and AE2, for example corresponding to coverage areas Z1 and Z2.

In 10, the microcontroller MC activates the antenna AE2 through is the antenna driver PI, that sends a signal in the coverage area Z2. The microcontroller M2 waits for a few tenths of a second to detect a response or lack of response from the identification device OI. In 20, the microcontroller MC then activates the antenna AE1 that sends a signal in the coverage area Z1, through the antenna driver PI. The microcontroller MC then waits for a few tenths of a second to detect a response or lack of response from the identification device OI.

At 30, the microcontroller MC combines the results of detections made at 10 and 20 to localize this identification device in area A or in area B as explained above, if the identification device responded. Depending on the area in which the identification device is localized, the microcontroller MC continues processing at 40 by putting into waiting (the identification device did not respond in either of the coverage areas Z1 and Z2), at 50 by unlocking the vehicle doors (the identification device responded in coverage area Z2 but not in Z1) and at 60 by authorization to start the vehicle (the identification device responded in coverage area Z1 but not in Z2).

The invention is also applicable to the case in which several identification devices can communicate with the recognition device that is capable of identifying each identification device.

1. An automobile vehicle (V) equipped with,a “hands-off” access system comprising a recognition device (DR) placed in the vehicle with several antennas (AE1, AE2), and a portable identification device (OI) for remote communication with the recognition device to automatically control locking or unlocking of the said vehicle doors and/or authorization to start the said vehicle, characterized in that the said antennas (AE1, AE2) have intersecting coverage areas (Z1, Z2, Z3), and in that the said recognition device is designed to activate each antenna in turn in order to detect a response or lack of response from the identification device depending on which antenna is activated and to localize the presence of the identification device in a particular coverage area of the said antennas based on detections of response or lack of response from the identification device as a function of which antennas are activated.
